(19) United States
(12) Patent Application Publication
(10) Pub. No.: US 2008/0085006 A1
(43) Pub. Date: Apr. 10, 2008

(54) Integrated multi-channel audio box

(76) Inventor: Wing Cheong Leung, Zhongshan (CN)

Correspondence Address: IPFortune LLC/Ruay Lian Ho;Suite 400, 1700 Pennsylvania Ave., NW, Washington, DC, 20006, US

(21) Appl. No.: 11/527,486

(22) Filed: Sep. 27, 2006

(51) Int. Cl. H04R 5/00; H04R 1/02

(52) U.S. Cl. 381/19; 381/18; 381/335

(57) ABSTRACT

The present invention relates to audio visual devices, and is aimed to provide an audio box with stereo surround effect; an integrated multi-channel audio box having simple structure and neat appearances, no complex wiring necessary to connect to the source. The structure of the audio box is in rectangular shape. There are three or more than three independent audio channels, including at least one base channel. The present invention adopts one audio box instead of the current stereo system structure with many audio boxes; three or more than three independent channels are integrated into one rectangular audio box, the wiring connection between the audio boxes and source is greatly simplified. Only one cable is necessary to carry out the communication among all channels, or wireless connection can be adopted.

### FIELD OF THE INVENTION

The present invention relates to the field of audio video equipments, specifically speaking, relates to an integrated multi-channel audio box.

### BACKGROUND OF THE INVENTION

In general, currently available stereo equipments have distributed structures. Namely, the right and left channel audio boxes are independent, bass and control circuits are closely arranged and wired together; the complex wire connections cause a messy stereo structure and unattractive appearances. It is also difficult for maintenance, and is time consuming trying to pin point breakdown when something is broken. Audio boxes having structure simulating several sound channels are now available; however, due to the incorporated channel simulation technique, wall reflection must be adopted in order to achieve the multi-channel surround effect. Therefore, the setting environment is very important; it takes a special building to house the audio boxes with several sound channels, which usually not available to common people. Bass is individually arranged in audio box for most modern stereo system, that is, at least two or more than two audio boxes are needed; one of them is for bass, like other systems, requiring complicated wiring.

The traditional amplifiers tend to have large size, and very thick; the thickness is usually more than 300 mm. But the thickness of nowadays popular flat TV is only about 150 mm, or less than 150 mm. It is apparent that current amplifiers do not fit into a home theater system of a flat TV. Several large sized audio boxes will occupy substantial space, and are not in conformity with a home theater system that normally has the flat TV set as the main feature of the system. In order to conform to the flat TV that has become the main stream of home theater systems, many stereo manufacturers have been trying to minimize the stereo size. In general, the currently available stereo equipments have distributed structure. Namely, the right and left channel audio boxes are independent, bass and control circuits are closely arranged, and wired together; the complex wire connections cause a messy stereo structure and unattractive appearances. It is also difficult for maintenance, and is time consuming trying to pin point the breakdown when something is broken.

### SUMMARY

It is an object of the present invention to provide an audio box with a stereo surround effect, simple structure, tidy appearance, and an integrated multi-channel without complicated wiring to the source.

It is another object of the present invention to provide an audio box that has an exterior appearance conforming to flat TV sets, good looking, and without heavy redundant wiring.

The objects of the present invention are implemented by some of the following exemplary embodiments.

An integrated multi-channel audio box is provided by the present invention; the exterior of the audio box is in rectangular shape, three or more than three individual channels are provided, wherein the channels include at least one base. The present invention replaces the combined plural speaker cabinets of the current stereo system structure with a single audio box, which contains three or more than three individual channels into a single rectangular audio box; hence, the wiring between the audio box and the source is substantially simplified, only one cable is necessary to carry out the communication between the channels and the source; of course, wireless communication can be utilized as well. The rectangular audio box housing unit improves the isolation among channels, and because of the configuration of the channel outputs is usually divided into left, middle, and right outputs, the rectangular audio box is therefore enforcing the lateral distribution of the channels; besides, the rectangular audio box provides ample resonate space for the bass channel, which guarantees the sound effect of the bass and enforces the surround effect during playing.

The present invention is applicable in various types of surround systems.

Regarding the 2.1 surround sound system audio box, there are three independent channels provided inside the audio box corresponding to left channel, right channel and bass channel respectively, wherein channels correspond to independent speakers or speaker sets respectively. Each channel can correspond to a speaker for playing its corresponding full frequency range, it can also correspond to a speaker set consisting of many speakers, wherein each speaker corresponds to certain frequency range; the entire speaker set covers the full frequency spectrum accordingly; the structure with a speaker set can cover wider frequency range, and have better sound quality. The audio box housing unit has a length to width radio 3:1˜60:1, the left and right channel speakers or speak sets are usually arranged at two sides of the rectangular audio box, the bass speaker or speaker set can be arranged at any position of the audio box providing it does not impact the other two channels, the best position is to be placed between left and right channel speakers or speaker sets. Because independent speakers or speaker sets are used for better isolation among channels by the present invention, the requirements of the setting environment for the audio box is not strict, and the audio box can perform well inside various building structures. The audio box of the present invention not only has simple wiring structure, which enables wide usage; but also is suitable to be used with the popular flat TV. The traditional amplifiers tend to have large size with substantial thickness; besides, it requires many audio boxes to form an audio box system; in a home theatre, the currently available amplifiers do not seem to be in conformity with flat TVs. And, the tidy simple rectangular shape structure of the present invention is in conformity with the flat TV style; the length of the audio box equals to the length of the flat TV, and the audio box can be placed above or under the flat TV, the entire home theater system has a very simple, tidy, and conforming appearances, satisfy the modern day home interior decor needs. Many different sources can be connected to the present invention, such as TV set, CD player, MP3 player, computer, video games etc.

Regarding 3.1 surround sound system audio box, four independent channels corresponding to the input sources are respectively provided inside the audio box, left channel, right channel, middle channel and base channel, these channels correspond to independent speakers or speaker sets respectively. The left, right and middle channel speakers or speaker sets are usually arranged at the two ends and middle of the rectangular audio box, the bass speaker or speaker set can be arranged at any position of the audio box providing it does not impact the other three channels, the best position is to be placed between the left and right channel speakers or speaker sets near middle channel speaker or speaker set. Four channel speakers or speaker sets can also be arranged evenly inside the audio box housing unit.

Regarding the 5.1 surround sound system audio box, there can be two structures, one structure is that six independent channels are respectively provided inside the audio box corresponding to the input sources, left channel, right channel, middle channel, rear left channel, rear right channel and base channel, these channels correspond to independent speakers or speaker sets respectively. Another structure is that one or more than one rear channels are set up on top of the 3.1 surround sound system structure, the rear channels are rectangular, there are two channels respectively corresponding to rear left and rear right input sources, the channels correspond to the independent speakers or speaker sets respectively. The rear channels and the 3.1 surround sound system can be connected by a cable or by a wireless connection, the entire system structure is simple, and having strong stereo sound effect.

Each and every channel of the audio box of the present invention can correspond to a single speaker or a speaker set; the audio box has limited space due to the rectangular shape housing unit adopted by the present invention; In order to guarantee the isolation of individual channel, it is better not to set up too many speakers. Usually, left channel and right channel, rear left channel and rear right channel are made of mid-range speakers and treble speakers respectively; for most homes, dividing the channels into mid-range speakers and treble speakers is enough to satisfy the home theatre sound effect requirements. In order to further improve the sound quality, the present invention can further divide the frequency, and set up a plurality of speakers respectively corresponding to each divided frequency range. For example, three speakers, four speakers etc., under the condition that the volume of the channel housing unit allows and the speaker allows, every channel can even correspond to more than ten speakers; left, right channels and middle channel can directly play, other channels can create a surround stereo sound effect through wall reflection. The present invention base channel can simply be structured with speakers like other channels; however, in order to ensure the sound quality, the present invention adopts the structure of base speaker and consonance box, and a plurality of guiding apertures are formed on the consonance box; the guiding apertures can be formed on the side surface of the consonance box to guarantee the guiding effect.

Under the design of the present invention, there is another integrated lateral multi-channel audio box particularly provided to be compatible with flat TV sets, including audio box housing unit, left speaker, right speaker and base speaker, the entire audio box housing unit is rectangular, its length to width ratio is 3:1˜60:1. The speakers are laterally located on top of the housing unit; left speaker, right speaker and base speaker correspond to the left, right and base channels respectively. The audio box structure of the present invention is suitable for both passive audio box and active audio box; for the passive audio box, only simple electrical connection is needed to build up the communication among speakers or speaker sets which correspond to each channel and source; this type of structure can really save space, the thickness of the audio box is directly determined by the thickness of the speaker; hence, it is possible to make the audio box very thin, and very small. But, this type of audio box needs to be connected to a source by amplifiers, such as a TV set with amplifier circuit, a CD player or a particularly provided independent amplifier etc. The active audio box is an audio box with build in amplifier circuit, the speaker is connected to source through the amplifier circuit, therefore, the size of this type audio box is slightly larger than the passive audio box with speakers of equivalent specifications; the advantage of the active audio box is that it can be adapted to various sources, whether the source is equipped with amplifier function or not, all it takes is to connect them directly; thus, external connection structure in contrast to the passive audio box is much simpler.

Provide left speaker, right speaker, base speaker and the amplifier circuit all inside the audio box housing unit; left speaker, right speaker and base speaker are connected together through an amplifier circuit; hence, the stereo system has no surplus circuit connection. Making the audio box housing unit rectangular, and placing left speaker, right speaker, base speaker into different positions of the stereo respectively give the rectangular audio box housing unit structure more separation distance among speakers; as a result, in usage, speakers do not interfere with each other, the sound quality of the audio box can be then ensured. The length and width of the present invention is equal to the length and width of the compatible flat TV, the ratio of the length of the audio box housing unit to the length of the compatible flat TV is in the range of 1:1˜1:1.2. In usage, the audio box can be installed on the wall above the flat TV, or on the cabinet stand under the flat TV. The installation is simple and easy, taking very little space; further, there is no complicated wiring connection between audio box and flat TV, a nice looking and harmonious home theatre system is formed. For the purpose of unifying the size of the modem day flat TV, the size of the audio box usually is under control to be within the range as follows, the length is 300˜1800 mm, the width is 30˜500 mm, the height is 50˜400 mm. The above listed size ranges are based on the size of the current flat TV, if, in the future, the flat TV is bigger and thinner, the present invention can extend the length limits of the audio box to be over 1800 mm and the width limits to be over 30 mm to accommodate the new structure of flat TV.

The above preferred embodiment is an improvement based on the 2.1 surround audio box; if making improvements based on the structure of a 3.1 surround audio box, the present invention would then require a middle speaker, which is located in the middle of the audio box. Middle speaker and left speaker, right speaker and base speaker are all the same connected by amplifier circuit; there is no redundant electrical wiring structure outside the audio box. To ensure the sound quality, isolation structure can be added between the middle speaker and the base speaker to further ensure the non-interference between middle speaker and base speaker, isolation structure can be a structure that is commonly used by the audio box.

To make improvements based on the 5.1 surround audio box, the present invention needs to add a separate rear audio box, the rear audio box is rectangular, its length to width ratio is between 3:1˜60:1, speakers allocated laterally; rear left speaker and rear right speaker are respectively located in positions near two ends of the rear audio box, and connected together by the amplifier circuit that locates inside the audio box housing unit; the length radio of the rear audio box to the audio box is between 1:1˜1:2. Rear audio boxes have the same structure as the audio box; every speaker and amplifier circuit is both placed inside the rectangular rear audio box. In addition, the length and the appearances have to be in conformity with the audio box, the entire home theater system can then have consistency and nice appearances. The present invention can also provide two smaller audio boxes of the same specifications at the left and right sides to construct 7.1 or even 9.1 surround audio box system.

Under normal condition, the audio box and the flat TV or stereo amplifier, the rear audio box and audio box are all connected by regular cable, but, because the connections between speakers are all placed inside the audio box housing unit and the rear audio box, hence, no external complicated connection structure is needed, only a cable for connecting the audio box and the flat TV or amplifier circuit, and a cable for connecting the rear audio box and audio box are necessary. It is obvious that the structure of the present invention is simple and convenient, easy to maintain, home theater based on the present invention does not have messy electricity circuit, its appearances is pretty and conforming. As the wireless communication technology develops, audio box can be connected to the flat TV wirelessly as well; audio box can also be connected to flat TV and rear audio box wirelessly. The adopted wireless communication technology can be those currently available technologies, such as infrared, radio frequency or Bluetooth etc.; it can also be the next generation wireless communication technology, which requires only adding a transmitter and a receiver to the corresponding members for the wireless communication. Adopting the wireless connection further simplifies the wiring structure of the home theatre; besides; each and every separate audio box, such as the rear audio box and the side audio box, is not restricted by the wiring and building structures, and can be placed at the indoor position having the best sound effect; the sound effect of the home theatre adopted the structure of the present invention can be further improved. For the purpose of cost saving and sound effect quality improving, the present invention may adopt a structure combining wire and wireless two types of connection, such as connecting the audio box and flat TV or amplifier circuit by a cable, and connecting the rear audio box and audio box with wire or wireless connection.

For adjusting to different flat TV configuration and constructing various home theatres, under the prerequisite of rectangular shape, the present invention can have many design structures to satisfy different requirements. The ordinary design structure is to make changes on the sectional surface of the audio box and rear audio box, such as square or rectangular or circle or half circle or triangle or curving or polygon types of regular shapes. The front look of audio box is a rectangular with length a lot more large than the height; however, it can be a strip wave design or an irregular strip that has a height on one end slightly larger than the height on the other end. Usually, the material used for the audio box and rear audio box housing unit is metal or plastic or wood; the material choice can be made according to the actual needs, such as choice based on indoor decor style or the user's taste; the conformity between home theater based on the members of the present invention and the interior style of the building is improved, better conforming appearances.

Except the base speaker, the above described each and every speaker can be formed by two or more than two sub-speakers; every sub-speaker covers different frequency range respectively.

In order to control the audio box conveniently and make users understand the operation condition of the audio box, a control circuit and a control display panel is added to the audio box of the present invention; the operation of the audio box can be controlled by a remote or a key pad, the audio box condition can be displayed by way of the LCD VFD LED or the like installed on the panel.

In comparison to the techniques available currently, the distinctive substantive features and substantial improvements of the present invention are made as follows.

1. Three or more than three channels are integrated into one audio box; a stereo system can be formed only by one audio box, there is no complicated wiring connection structure between the audio box and source, simple structure, easy to install and maintain;

### 2. Isolation between channels is easy to achieve with adopted rectangular structure; each and every channel does not interfere with each other, the sound effect can then be guaranteed;

3. The adopted independent speaker or speaker set can broadcast for each and every channel independently; no redundant simulation technology required, and compatible to various building interior environment; actually location can be randomly chosen; can be used broadly and easily;

### 4. Forming a stereo system with many sources, the present utility model audio box has rectangular shape structure, is able to conform to flat TV, and can form a conforming nice looking home theatre.

### 5. The adopted wireless connection further simplifies the entire home system, making the home theatre more conforming and good looking;

### 6. There are various structures and materials to meet the needs of various users and different home theater styles.

### DESCRIPTION OF THE DRAWINGS

The present invention can be further described in details by combining the following attached drawings with the preferred embodiments:

FIG. 1 illustrates a module diagram showing the principle of the first preferred embodiment;

FIG. 2 illustrates a structural schematic diagram of the first preferred embodiment;

FIG. 3 illustrates a usage diagram of the first preferred embodiment;

FIG. 4 illustrates a module diagram showing the principle of the second preferred embodiment;

FIG. 5 illustrates a structural schematic diagram showing the principle of the second preferred embodiment;

FIG. 6 illustrates a usage diagram of the second preferred embodiment;

FIG. 7 illustrates a schematic diagram showing the side view of FIG. 5;

FIG. 8 illustrates a module diagram showing the principle of the third preferred embodiment;

FIG. 9 illustrates a structural schematic diagram of the third preferred embodiment;

FIG. 10 illustrates a usage diagram of the third preferred embodiment;

FIG. 11 illustrates a module diagram showing the principle of the fourth preferred embodiment;

FIG. 12 illustrates a structural schematic diagram of the fourth preferred embodiment;

FIG. 13 illustrates a usage diagram of the fourth preferred embodiment;

FIG. 14 illustrates a module diagram showing the principle of the fifth preferred embodiment;

FIG. 15 illustrates a structural schematic diagram of the fifth preferred embodiment;

FIG. 16 illustrates a usage diagram of the fifth preferred embodiment.

### DETAILED DESCRIPTION OF THE INVENTION

The present invention can be further described in details by combining the following attached drawings with the preferred embodiments.

### Preferred Embodiment 1

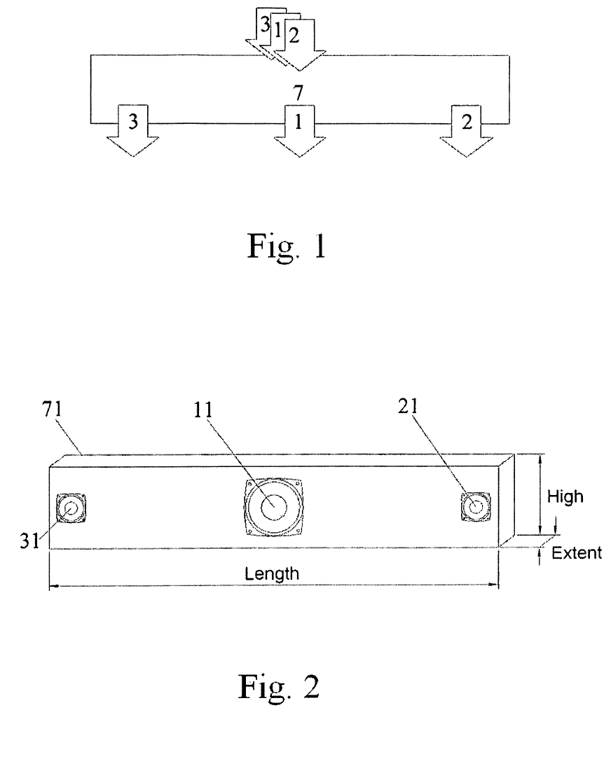

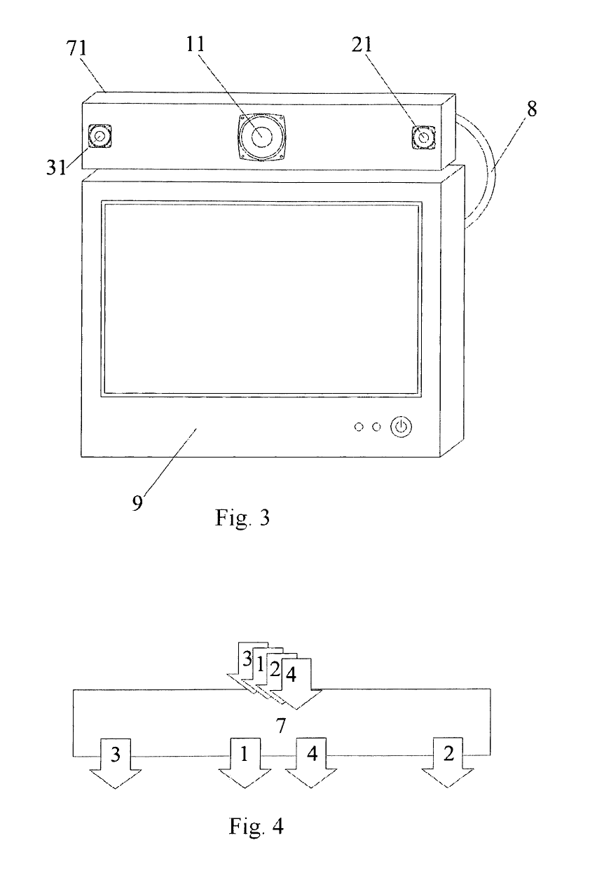

The present preferred embodiment provides an integrated multi-channel audio box that is compatible to 2.1 surround system; as shown in the principle module diagram of FIG. 1, there are three independent channels in audio box 7, respectively bass channel 1, right channel 2 and left channel 3; the three channels are together inputted into the audio box 7 from the source, and outputted to different places of the audio box 7 respectively. As shown in FIG. 2, the audio box housing unit 71 is in rectangular; the ratio of length to width is 30:1; height to width is 2:1; bass channel 1, right channel 2 and left channel 3 respectively correspond to a single bass speaker 11, right speaker 21 and left speaker 31; the bass speaker 11 is provided in the middle of the audio box housing unit 71, the right speaker 21 and the left speaker 31 are respectively provided at two sides of the bass speaker 11. In usage, as shown in FIG. 3, the audio box 7 is connected to the flat TV 9 by a single cable 8, the flat TV 9 outputs three channels from the source to the audio box 7 by the cable 8, without complex connection wire construction, simple and pretty structure; furthermore, the rectangular structure of audio box housing unit 71 of the present embodiment can conform to the appearances of the flat TV 9, forming a good looking stereo system.

### Preferred Embodiment 2

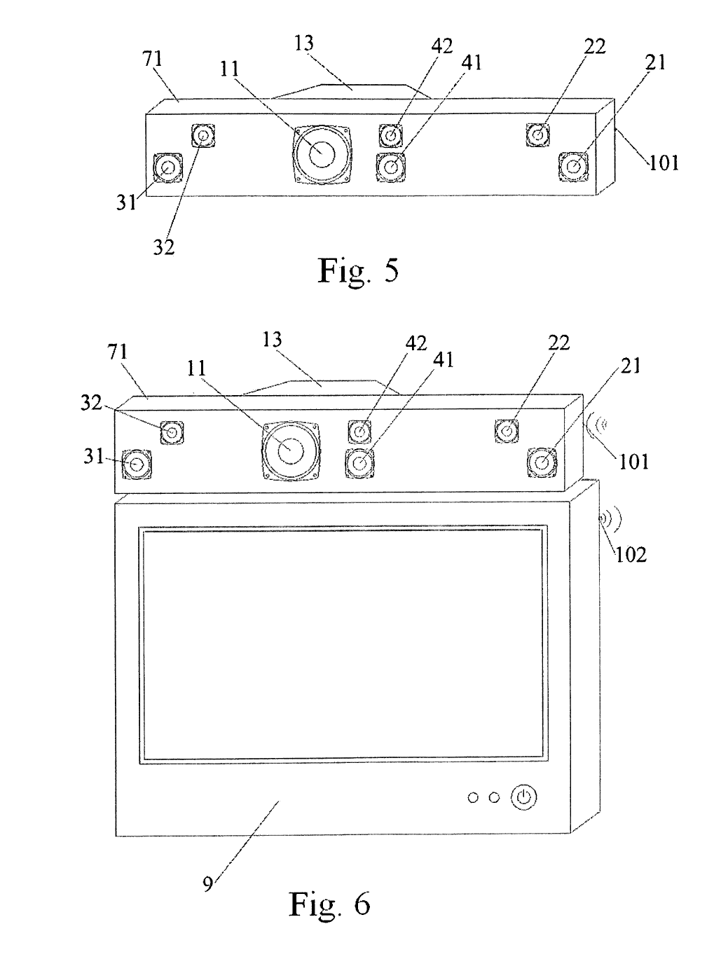

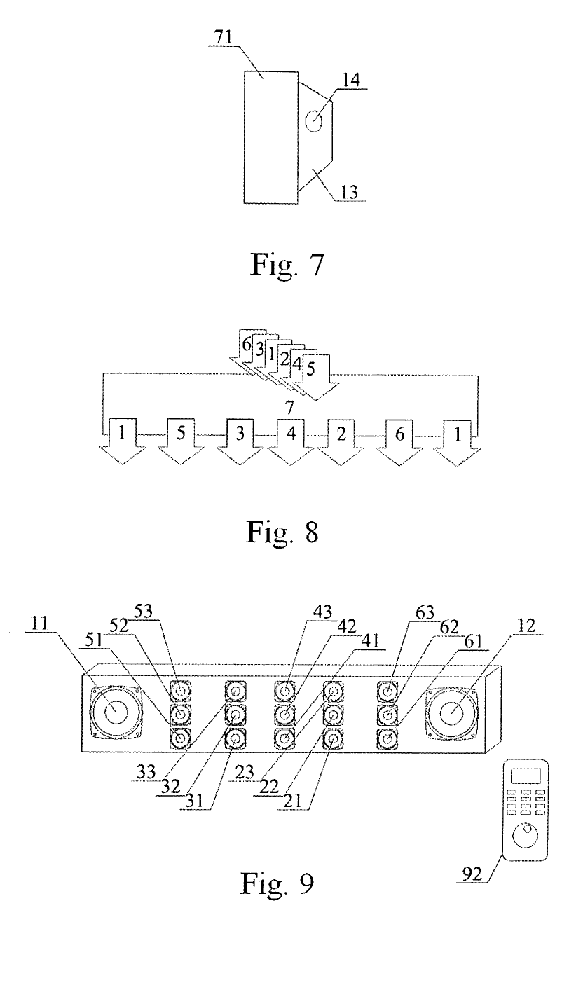

The present preferred embodiment provides an integrated multi-channel audio box that is compatible to 3.1 surround system; as shown in the module diagram of FIG. 4, there are four independent channels provided in audio box 7, they are bass channel 1, right channel 2, left channel 3 and middle channel 4; the four channels are together inputted into the audio box 7 from the source; the right channel 2, the left channel 3 are respectively outputted from the right and left sides of the audio box 7; the base channel 1 and the middle channel 4 are outputted from the center of the audio box 7. As shown in FIG. 5, the audio box housing unit 71 is rectangular; the base channel 1 is formed by a base speaker 11 and a consonant box 13; a plurality of guiding apertures 14 are formed on the consonance box 13, as shown in the side view diagram of FIG. 7. The right channel 2, the left channel 3 and the middle channel 4 respectively correspond to two speakers 21 and 22, 31 and 32, 41 and 42; each and every channel has two speakers that respectively correspond to the mid frequency and high frequency outputs. The right speaker 21, 22 and the left speakers 31, 32 are provided at the right and left sides of the audio box housing unit 71, the middle speakers 41 and 42 are provided at the center of the audio box housing unit 71 and next to the base speaker 11, the standard of picking positions at the audio box housing unit 71 for the speakers or speaker sets used for outputs from different channels should be no interference; if necessary, special isolation structure can be installed inside the audio box housing unit 71. The audio box system formed by the present preferred embodiments and flat TV 9, as shown in FIG. 6, has a wireless receiving device 101 provided at the audio box housing unit 71, and a wireless transmitting device 102 at the flat TV 9, sound signal transmission is then established by these two devices. Cable connection is not necessary, and the entire stereo system has a very conforming and unified appearance.

### Preferred Embodiment 3

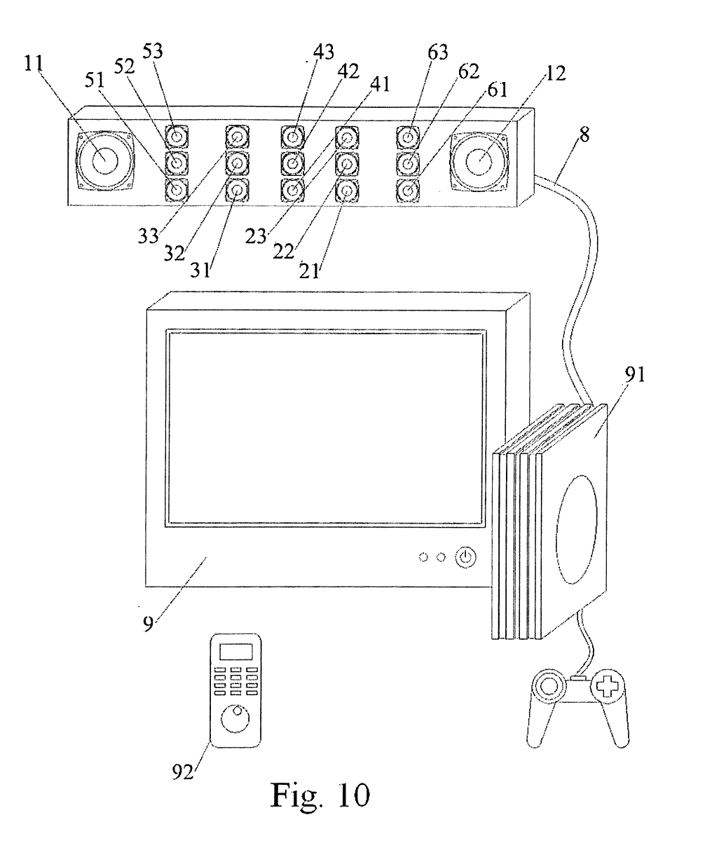

The present preferred embodiment provides six independent channels inside the audio box 7 where each channel corresponds to left channel 3, right channel 2, middle channel 4, rear left channel 5, rear right channel 6 and base channel 1 respectively, as shown in FIG. 8; the bass channel 1 of the present preferred embodiment outputs from the right and left sides of the audio box 7; the rest of the channels output at the conventional corresponding positions of the audio box 7 respectively. The audio box structure as shown in FIG. 9, base speakers 11 and 12 are located at the left and right sides of the audio box housing unit 71, the right channel 2, the left channel 3, the middle channel 4, rear left channel 5 and rear right channel 6 respectively correspond to three speaker sets 21 and 22 and 23, 31 and 32 and 33, 41 and 42 and 43, 51 and 52 and 53, 61 and 62 and 63; the channels corresponding to speaker sets respectively correspond to outputs of low frequency, mid frequency, and high frequency. The present preferred embodiment is equipped with remote control 92 to conveniently operate audio box 7 remotely. The present preferred invention is compatible with various sources, such as CD players, MP3 player, TV or computer etc., FIG. 10 shows a connection to video games, only a cable 8 is necessary to connect to the sound output connector of the video game 91 and a 5.1 surround system can be formed; the video game will be played as real game, simulating virtual reality.

### Preferred Embodiment 4

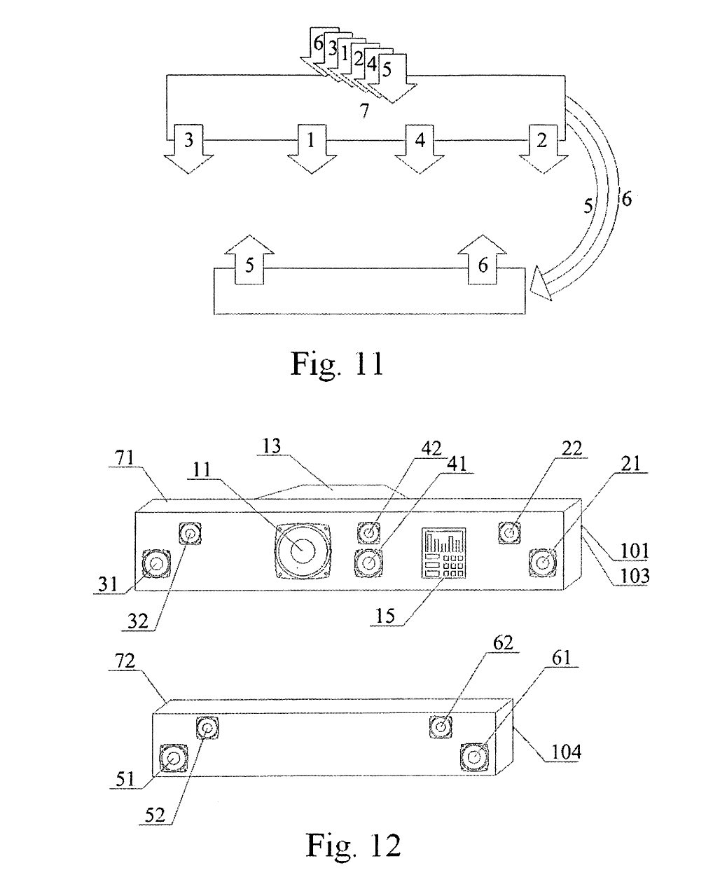

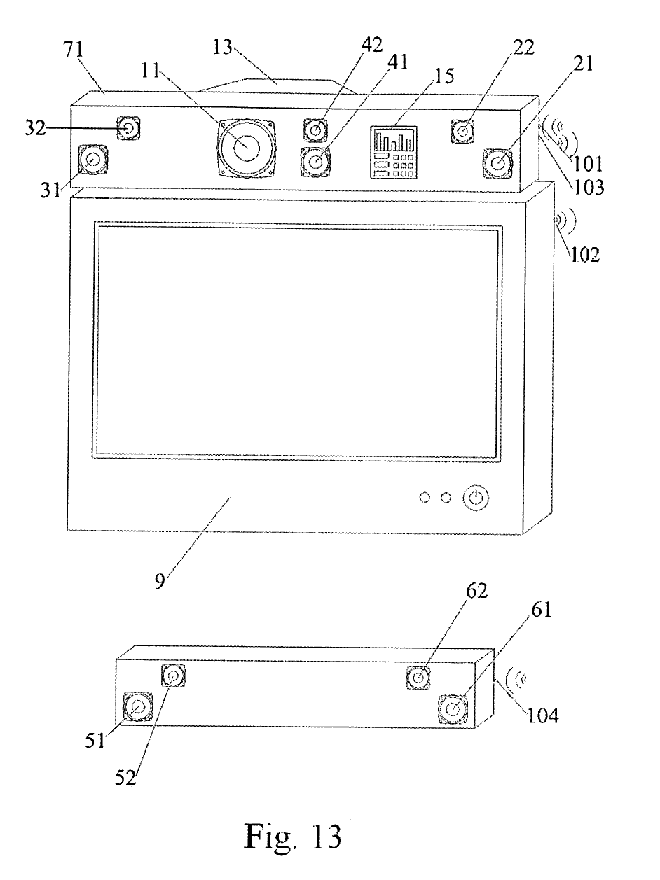

The present preferred embodiment provides an integrated audio box, improvements made based on the preferred embodiment 2 configuration; a 3.1 surround system is improved into a 5.1 surround system, the improvement changes include further set up a rear audio box for a rear left channel 5 and rear right channel 6 output. As shown in FIG. 11, sources are inputted into the audio box 7 by way of left channel 3, right channel 2, middle channel 4, rear left channel 5, rear right channel 6 and base channel 1; audio box 7 only outputs the left channel 3, the right channel 2, the middle channel 4 and the bass channel 1 four channels, and the rear left channel 5, rear right channel 6 are outputted by the rear audio box. The rear audio box structure is shown in FIG. 12, the rear audio box housing unit 72 is rectangular, conforming to the shape of the audio box housing unit 71; the left channel 3, the right channel 2, the middle channel 4 and base channel 1 four channels correspond to speaker sets 31 and 32, 21 and 22, 41 and 42, wherein the structure is similar to the structure of preferred embodiment 2; the difference from the preferred embodiment 2 is that the present preferred embodiment further provides a control panel 15 at the audio box housing unit 71, users can therefore control the audio box conveniently and the operation condition can be displayed as well. The rear left channel 5 and rear right channel 6 correspond to the speaker sets 51 and 52, 61 and 62 are provided at the conventional left and right sides of the audio box housing unit 71. The present preferred embodiment in use is shown in FIG. 13, the audio box housing unit in usage is installed facing the users, speakers face the users directly; these positions are above or under the flat TV 9, rear audio box housing unit 72 is placed behind the users, speakers face the back of the users, audio box 7 and flat TV 9 are connected wirelessly by a wireless receiving device 101 and a wireless transmitting device 102, audio box 7 and rear audio box are connected wirelessly by a wireless receiving device 104 and a wireless transmitting device 103. Because both the audio box housing unit 71 and the rear audio box housing unit 72 are in rectangular, a stereo system conforming to flat TVs can be formed; besides, no cable connection necessary with this type wireless separation audio box structure; the entire structure is simple, neat, and having great stereo surround effect.

### Preferred Embodiment 5

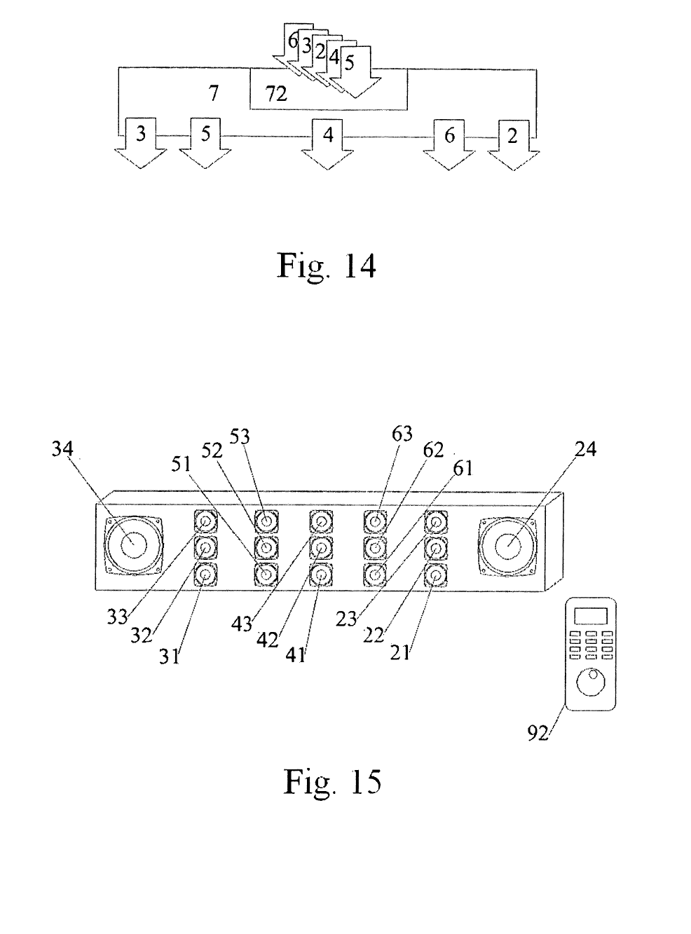

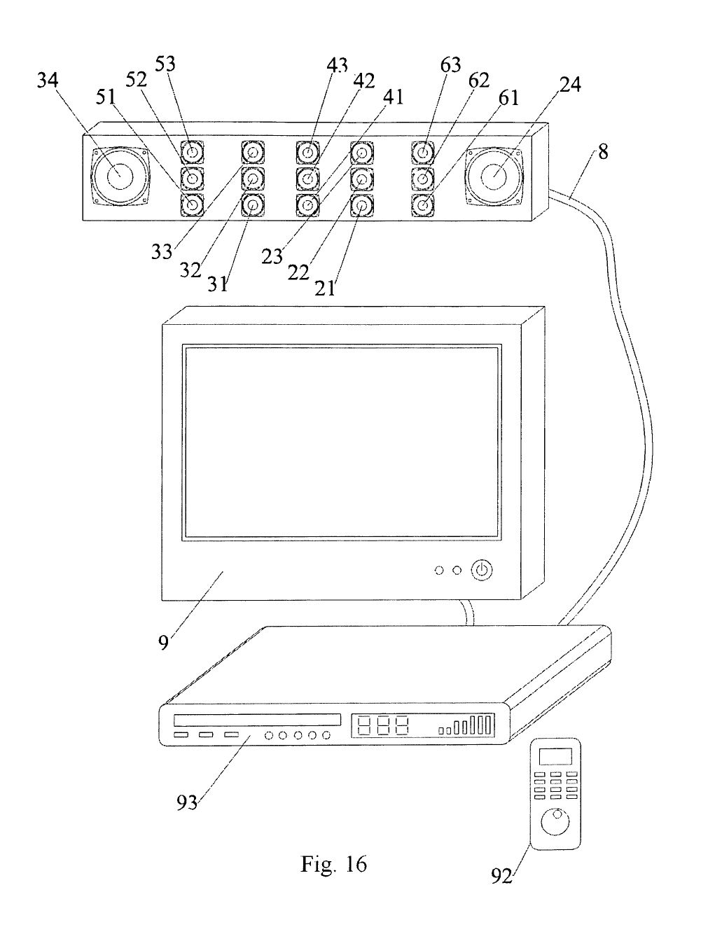

The present preferred embodiment provides five independent channels inside the audio box 7 where each channel corresponds to left channel 3, right channel 2, middle channel 4, rear left channel 5 and rear right channel 6 respectively; each channel connects to the source by an amplifier circuit 72, as shown in FIG. 14; each channel of the present preferred embodiment respectively outputs at the conventional corresponding position at the audio box housing unit 71. The audio box structure as shown in FIG. 15, right channel 2, left channel 3, middle channel 4, rear left channel 5 and rear right channel 6 respectively correspond to three speaker sets 21 and 22 and 23, 31 and 32 and 33, 41 and 42 and 43, 51 and 52 and 53, 61 and 62 and 63; the channels corresponding to speaker sets respectively correspond to outputs of low frequency, mid frequency, and high frequency; two base speakers 34 and 24 are particularly provided for left right channel at the left right two sides of the audio box housing unit 71. The present preferred embodiment is further equipped with remote control 92 to conveniently control audio box 7 operation remotely. The present invention is compatible with various sources, such as CD players, MP3 player, TV or computer etc.; FIG. 16 shows a connection to DVD player 93, only a cable 8 is necessary to connect to the sound output connector of the DVD player 93 and a 5.1 surround system can be formed; the movie will be shown with better effect, simulating reality.

What we claimed is:

1. An integrated multi-channel audio box comprises a rectangular audio box housing unit, which contains three or more than three independent channels.

2. The integrated multi-channel audio box as claimed in claim 1, wherein the three or more than three independent channels include at least one bass channel.

3. The integrated multi-channel audio box as claimed in claim 2, wherein the 3 independent channels respectively corresponding to left channel, right channel and bass channel with input sources; and the channels respectively corresponding to mutually independent speakers or speaker sets.

4. The integrated multi-channel audio box as claimed in claim 2, wherein the 4 independent channels respectively corresponding to left channel, right channel, middle channel and bass channel with input sources; and the channels respectively corresponding to mutually independent speakers or speaker sets.

5. The integrated multi-channel audio box as claimed in claim 4 further comprises a rear audio box having a rectangular housing unit; the rectangular housing unit containing two channels corresponding to a source input left channel and a source input right channel respectively; and the channels correspond to mutually independent speakers or speaker sets respectively.

6. The integrated multi-channel audio box as claimed in claim 2, wherein the 6 independent channels respectively corresponding to left channel, right channel, middle channel, rear left channel, rear right channel and bass channel with input sources; and the channels respectively corresponding to mutually independent speakers or speaker sets.

7. The integrated multi-channel audio box as claimed in claim 6, wherein the left channel, the right channel, the middle channel, the rear left channel and the rear right channel correspond to two or more than two speakers for different frequency ranges.

8. The integrated multi-channel audio box as claimed in claim 6, wherein the left channel, the right channel, the middle channel, the rear left channel and rear right channel are consisted of mid-range frequency and a high-range frequency speakers respectively.

9. The integrated multi-channel audio box as claimed in claim 8, wherein the base channel is consisted of base speaker and resonance box; the resonance box having a plurality of guiding holes.

10. The integrated multi-channel audio box as claimed in claim 6, wherein the base channel is consisted of base speaker and resonance box; the resonance box having a plurality of guiding holes.

11. An integrated multi-channel audio box comprises:
a housing unit with length to width ratio of 3:1 to 60:1; and
a left channel, a right channel and bass channel corresponding to left speaker, right speaker and bass speaker respectively are provided laterally at the rectangular housing unit.

12. The integrated multi-channel audio box as claimed in claim 11 further comprises an amplifier circuit which connects speakers to the sources.

13. The integrated multi-channel audio box as claimed in claim 12, wherein the length of the housing unit conforming to a flat TV with a ratio of 1:1 to 1:1.2.

14. The integrated multi-channel audio box as claimed in claim 13, wherein the length of the housing unit is between 300 mm and 1800 mm; the width is between 30 mm and 500 mm; and the height is between 50 and 400 mm.

15. The integrated multi-channel audio box as claimed in claim 11 further comprises a middle speaker corresponding to a middle channel for source input.

16. The integrated multi-channel audio box as claimed in claim 15, wherein the left speaker, right speaker and middle speaker are comprised by two or more than two sub-speakers corresponding to different frequency ranges.

17. The integrated multi-channel audio box as claimed in claim 11 further comprises a separate rear audio box having a rectangular housing unit with the ratio of length to width between 3 to 1 and 60 to 1; a rear left speaker and a rear right speaker are provided laterally at the two sides of the rear audio box; and the ratio of audio box to the housing unit is between 1:1 and 1:2.

18. The integrated multi-channel audio box as claimed in claim 17, wherein the left speaker, the right speaker, the middle speaker, the rear left speaker and the rear right speaker are comprised by two or more than two sub-speakers corresponding to different frequency arranges.

19. The integrated multi-channel audio box as claimed in claim 11, wherein the left speaker and right speaker are comprised by two or more than two sub-speakers corresponding to different frequency ranges.

20. The integrated multi-channel audio box as claimed in claim 11 further comprises a control panel at the audio box housing unit.
